(19) United States
(12) Patent Application Publication
(10) Pub. No.: US 2012/0167572 A1
(43) Pub. Date: Jul. 5, 2012

(54) GAS TURBINE ENGINE AND DIFFUSER

(76) Inventors: Edward Claude Rice, Indianapolis, IN (US); Jack Dwane Petty, Indianapolis, IN (US); Bruce Edward Varney, Greenwood, IN (US); Mindi Danette Wigal, Columbus, IN (US)

(21) Appl. No.: 13/335,443

(22) Filed: Dec. 22, 2011

Related U.S. Application Data
(60) Provisional application No. 61/428,787, filed on Dec. 30, 2010.

(51) Int. Cl. F02C 3/04

(52) U.S. Cl. 60/751

(57) ABSTRACT

One embodiment of the present invention is a unique gas turbine engine. Other embodiments include apparatuses, systems, devices, hardware, methods, and combinations for gas turbine engines and components thereof. Further embodiments, forms, features, aspects, benefits, and advantages of the present application will become apparent from the description and figures provided herewith.

### CROSS REFERENCE TO RELATED APPLICATIONS

The present application claims benefit of U.S. Provisional Patent Application No. 61/428,787, filed Dec. 30, 2010, entitled GAS TURBINE ENGINE AND DIFFUSER, which is incorporated herein by reference.

### FIELD OF THE INVENTION

The present invention relates to gas turbine engines, and more particularly to gas turbine engine components, such as a diffuser.

### BACKGROUND

Gas turbine engines and components, such as diffusers and combustors, remain an area of interest. Some existing systems have various shortcomings, drawbacks, and disadvantages relative to certain applications. Accordingly, there remains a need for further contributions in this area of technology.

### SUMMARY

One embodiment of the present invention is a unique gas turbine engine. Other embodiments include apparatuses, systems, devices, hardware, methods, and combinations for gas turbine engines and components thereof. Further embodiments, forms, features, aspects, benefits, and advantages of the present application will become apparent from the description and figures provided herewith.

### BRIEF DESCRIPTION OF THE DRAWINGS

The description herein makes reference to the accompanying drawings wherein like reference numerals refer to like parts throughout the several views, and wherein:

FIG. 1 schematically illustrates a non-limiting example of some aspects of a gas turbine engine in accordance with an embodiment of the present invention.

FIG. 2 illustrates a non-limiting example of some aspects of a diffuser splitter in accordance with an embodiment of the present invention.

FIG. 3 illustrates a non-limiting example of some aspects of a combustor in accordance with an embodiment of the present invention.

FIG. 4 illustrates a non-limiting example of some aspects of a combustor dome panel in accordance with an embodiment of the present invention.

### DETAILED DESCRIPTION

For purposes of promoting an understanding of the principles of the invention, reference will now be made to the embodiments illustrated in the drawings, and specific language will be used to describe the same. It will nonetheless be understood that no limitation of the scope of the invention is intended by the illustration and description of certain embodiments of the invention. In addition, any alterations and/or modifications of the illustrated and/or described embodiment(s) are contemplated as being within the scope of the present invention. Further, any other applications of the principles of the invention, as illustrated and/or described herein, as would normally occur to one skilled in the art to which the invention pertains, are contemplated as being within the scope of the present invention.

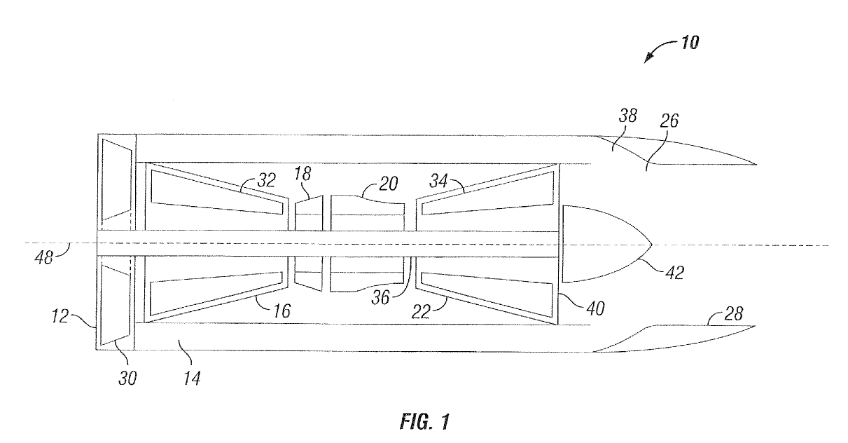

Referring to the drawings, and in particular FIG. 1, a non-limiting example of some aspects of a gas turbine engine 10 in accordance with an embodiment of the present invention is schematically depicted. In one form, gas turbine engine 10 is an aircraft propulsion power plant. In other embodiments, gas turbine engine 10 may be a land-based or marine engine. In one form, gas turbine engine 10 is a multi-spool turbofan engine. In other embodiments, gas turbine engine 10 may take other forms, and may be, for example, a turboshaft engine, a turbojet engine, a turboprop engine, or a combined cycle engine having a single spool or multiple spools.

As a turbofan engine, gas turbine engine 10 includes a fan system 12, a bypass duct 14, a compressor 16, a diffuser 18, a combustor 20, a turbine 22, a discharge duct 26 and a nozzle system 28. Bypass duct 14 and compressor 16 are in fluid communication with fan system 12. Diffuser 18 is in fluid communication with compressor 16. Combustor 20 is fluidly disposed between compressor 16 and turbine 22. In one form, combustor 20 includes a combustion liner (not shown) that contains a continuous combustion process. In other embodiments, combustor 20 may take other forms, and may be, for example and without limitation, a wave rotor combustion system, a rotary valve combustion system or a slinger combustion system, and may employ deflagration and/or detonation combustion processes.

Fan system 12 includes a fan rotor system 30. In various embodiments, fan rotor system 30 includes one or more rotors (not shown) that are powered by turbine 22. Bypass duct 14 is operative to transmit a bypass flow generated by fan system 12 to nozzle 28. Compressor 16 includes a compressor rotor system 32. In various embodiments, compressor rotor system 32 includes one or more rotors (not shown) that are powered by turbine 22. Each compressor rotor includes a plurality of rows of compressor blades (not shown) that are alternatingly interspersed with rows of compressor vanes (not shown). Turbine 22 includes a turbine rotor system 34. In various embodiments, turbine rotor system 34 includes one or more rotors (not shown) operative to drive fan rotor system 30 and compressor rotor system 32. Each turbine rotor includes a plurality of turbine blades (not shown) that are alternatingly interspersed with rows of turbine vanes (not shown).

Turbine rotor system 34 is drivingly coupled to compressor rotor system 32 and fan rotor system 30 via a shafting system 36. In various embodiments, shafting system 36 includes a plurality of shafts that may rotate at the same or different speeds and directions. In some embodiments, only a single shaft may be employed. Turbine 22 is operative to discharge an engine 10 core flow to nozzle 28. In one form, fan rotor system 30, compressor rotor system 32, turbine rotor system 34 and shafting system 36 rotate about an engine centerline 48. In other embodiments, all or parts of fan rotor system 30, compressor rotor system 32, turbine rotor system 34 and shafting system 36 may rotate about one or more other axes of rotation in addition to or in place of engine centerline 48.

Discharge duct 26 extends between a discharge portion 40 of turbine 22 and engine nozzle 28. Discharge duct 26 is operative to direct bypass flow and core flow from a bypass duct discharge portion 38 and turbine discharge portion 40, respectively, into nozzle system 28. In some embodiments, discharge duct 26 may be considered a part of nozzle 28. Nozzle 28 is in fluid communication with fan system 12 and turbine 22. Nozzle 28 is operative to receive the bypass flow from fan system 12 via bypass duct 14, and to receive the core flow from turbine 22, and to discharge both as an engine exhaust flow, e.g., a thrust-producing flow. In other embodiments, other nozzle arrangements may be employed, including separate nozzles for each of the core flow and the bypass flow.

During the operation of gas turbine engine 10, air is drawn into the inlet of fan 12 and pressurized by fan 12. Some of the air pressurized by fan 12 is directed into compressor 16 as core flow, and some of the pressurized air is directed into bypass duct 14 as bypass flow, and is discharged into nozzle 28 via discharge duct 26. Compressor 16 further pressurizes the portion of the air received therein from fan 12, which is then discharged into diffuser 18. Diffuser 18 reduces the velocity of the pressurized air, and directs the diffused core airflow into combustor 20. Fuel is mixed with the pressurized air in combustor 20, which is then combusted. The hot gases exiting combustor 20 are directed into turbine 22, which extracts energy in the form of mechanical shaft power sufficient to drive fan system 12 and compressor 16 via shafting system 36. The core flow exiting turbine 22 is directed along an engine tail cone 42 and into discharge duct 26, along with the bypass flow from bypass duct 14. Discharge duct 26 is configured to receive the bypass flow and the core flow, and to discharge both as an engine exhaust flow, e.g., for providing thrust, such as for aircraft propulsion.

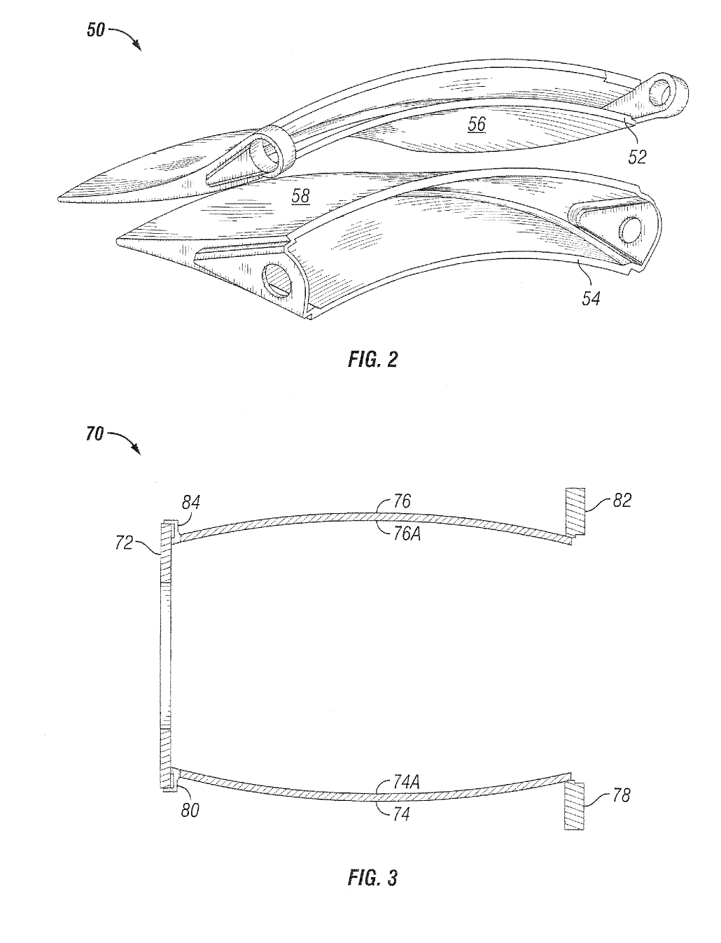

Referring now to FIG. 2, in one form, diffuser 18 includes a plurality of splitters 50. In other embodiments, diffuser 18 may take other forms, and may be, for example and without limitation, a dump diffuser and/or one or more other diffuser types. Diffuser 18 is formed, in part, of a foam material. Splitters 50 are configured to form multiple passages within diffuser 18. Splitters 50 form walls for diffusing pressurized air received from compressor 16 and for directing the flow of diffused air toward desired locations on and around combustor 20. Each splitter 50 includes an upper splitter portion 52 and a lower splitter portion 54. In one form, both upper splitter portion 52 and lower splitter portion 54 are formed of a foam material. In other embodiments, only one of upper splitter portion 52 and lower splitter portion 54 may be formed of a foam material.

In one form, the foam material has a closed cell structure. In other embodiments, an open cell structure may be employed in addition to or in place of a closed cell structure. In one form, the foam material is a metal foam having a density substantially lower than the same material in a fully dense form. In some embodiments, upper splitter portion 52 and lower splitter portion 54 are formed by casting foamed metal, yielding a density as low as 4% of that of the same metal in a typical fully dense state. In other embodiments, other densities may be achieved. In one form, the metal foam is a high temperature nickel foam. In other embodiments, other metallic materials may be employed. In still other embodiments, the foam material may be an intermetallic foam and/or a ceramic foam in addition to or in place of metal foam. Examples of materials that may be used to create intermetallic and ceramic foams include, for example and without limitation, alumina and SIC.

Upper splitter portion 52 and lower splitter portion 54 include respective flowpath surfaces 56 and 58. In one form, disposed on flowpath surfaces 56 and 58 is a coating. In one form, the coating is applied directly over the foam material forming flowpath surfaces 56 and 58. In other embodiments, other portions of upper splitter portion 52 and lower splitter portion 54 may have the coating disposed on other surfaces in addition to or in place of flowpath surfaces 56 and 58. In still other embodiments, upper splitter portion 52 and lower splitter portion 54 may have any number of coatings disposed thereon. In one form, the coating is a ceramic material, for example and without limitation alumina and SiC. In other embodiments, other coating materials may be employed, for example and without limitation, metallic and/or intermetallic coatings such as high temperature capable nickel alloys.

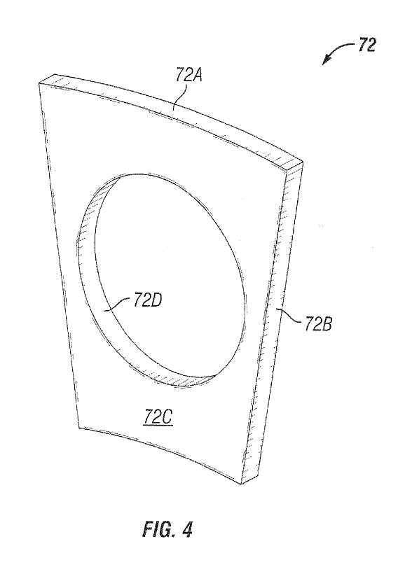

Referring now to FIGS. 3 and 4, in one form, combustor 20 includes a combustion liner 70 and plurality dome panels 72 disposed at a forward portion of combustion liner 70. In other embodiments, only a single dome panel 72 may be employed. Combustion liner 70 includes an inner liner 74 and an outer liner 76. In one form, inner liner 74 includes attachment features 78 and 80; and outer liner 76 includes attachment features 82 and 84. Attachment 78, 80, 82 and 84 are configured to attach combustion liner 70 to engine 10, and to secure dome panels 72 to combustion liner 70. In one form, dome panels 72 are formed of a foam material. In one form, the foam material has a closed cell structure. In other embodiments, an open cell structure may be employed in addition to or in place of a closed cell structure. In one form, the foam material is a metal foam having a density substantially lower than the same material in a fully dense form. In some embodiments, dome panels 72, inner liner 74 and outer liner 76 are formed by casting foamed metal, yielding a density as low as 4% of that of the same metal in a typical fully dense state. In other embodiments, other densities may be achieved. In one form, the metal foam is a high temperature nickel alloy. In other embodiments, other metallic materials may be employed. In still other embodiments, the foam material may be an intermetallic foam and/or a ceramic foam in addition to or in place of metal foam. Examples of materials that may be used to create intermetallic and ceramic foams include, for example and without limitation, alumina and SiC.

Dome panel 72 is defined by a plurality of surfaces, some of which are illustrated as surfaces 72A, 72B, 72C and 72D. In one form, one or more surfaces of dome panel 72, including but not limited to one or more of 72A, 72B, 72C and 72D and/or other surfaces not explicitly illustrated, have one or more coatings disposed thereon, including, for example and without limitation, thermal protection (high temperature resistant) coatings. Similarly, in various embodiments, one or more surfaces of combustion liner 70, for example and without limitation, inner combustion surfaces 74A and 76A, have one or more coatings disposed thereon, including, for example and without limitation, thermal protection (high temperature resistant) coatings. In one form, the coatings include a coating formed of a ceramic material, for example and without limitation, alumina and SiC. In other embodiments, other coating materials may be employed, for example and without limitation, metallic and/or intermetallic coatings such as high temperature capable nickel alloys. It will be understood that the foam material and/or coating(s) disposed thereon may be the same or different for each of diffuser 18, including upper splitter portion 52 and a lower splitter portion 54, and for dome panels 72 and inner liner 74 and outer liner 76.

Embodiments of the present invention include a gas turbine engine, comprising: a compressor; a diffuser in fluid communication with the compressor; a combustor in fluid communication with the diffuser; and a turbine in fluid communication with the combustor, wherein the diffuser is formed at least in part of a first foam material.

In a refinement, the diffuser includes a splitter; and wherein the splitter is formed of the first foam material.

In another refinement, the splitter includes an upper splitter and a lower splitter.

In yet another refinement, both the upper splitter and the lower splitter are formed of the first foam material.

In still another refinement, the first foam material has a closed cell structure.

In yet still another refinement, the first foam material is a metal foam.

In a further refinement, the gas turbine engine further comprises a coating disposed on the first foam material.

In a yet further refinement, the coating is a ceramic material.

In a still further refinement, the coating is a metallic material.

In a yet still further refinement, the combustor includes a dome panel; and wherein the dome panel is formed of a second foam material.

Embodiments of the present invention include a diffuser for a gas turbine engine, comprising: a first splitter component; and a second splitter component, wherein one or both of the first splitter component and the second splitter component are formed of a foam material.

In a refinement, both the first splitter component and the second splitter component are formed of the foam material.

In another refinement, first foam material has a closed cell structure.

In yet another refinement, the foam material is a metal foam.

In still another refinement, the diffuser further comprises a coating disposed on the foam material.

In yet still another refinement, the coating is a ceramic material.

In a further refinement, the coating is a metallic material.

In a yet further refinement, the first splitter component and the second splitter component each have a flowpath surface; and wherein the coating is disposed on the flowpath surface of each of the first splitter component and the second splitter component.

Embodiments of the present invention include a gas turbine engine, comprising: a compressor; means for diffusing pressurized air received from the compressor; a combustor in fluid communication with the means for diffusing; and a turbine in fluid communication with the combustor, wherein the means for diffusing is formed at least in part of a first foam material.

In a refinement, the combustor includes a dome panel; wherein the dome panel is formed of a second foam material.

In another refinement, the gas turbine engine further comprises a thermal protection coating disposed on the second foam material.

In yet another refinement, the combustor includes a combustion liner formed at least in part of a third foam material.

In still another refinement, the gas turbine engine further comprises a thermal protection coating disposed on the third foam material.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. A gas turbine engine, comprising:
a compressor;
a diffuser in fluid communication with the compressor;
a combustor in fluid communication with the diffuser; and
a turbine in fluid communication with the combustor,
wherein the diffuser is formed at least in part of a first foam material.

2. The gas turbine engine of claim 1, wherein the diffuser includes a splitter; and
wherein the splitter is formed of the first foam material.

3. The gas turbine engine of claim 2, wherein the splitter includes an upper splitter and a lower splitter.

4. The gas turbine engine of claim 3, wherein both the upper splitter and the lower splitter are formed of the first foam material.

5. The gas turbine engine of claim 1, wherein the first foam material has a closed cell structure.

6. The gas turbine engine of claim 1, wherein the first foam material is a metal foam.

7. The gas turbine engine of claim 1, further comprising a coating disposed on the first foam material.

8. The gas turbine engine of claim 7, wherein the coating is a ceramic material.

9. The gas turbine engine of claim 7, wherein the coating is a metallic material.

10. The gas turbine engine of claim 1, wherein the combustor includes a dome panel; and wherein the dome panel is formed of a second foam material.

11. A diffuser for a gas turbine engine, comprising:
a first splitter component; and
a second splitter component,
wherein one or both of the first splitter component and the second splitter component are formed of a foam material.

12. The diffuser of claim 11, wherein both the first splitter component and the second splitter component are formed of the foam material.

13. The diffuser of claim 11, wherein first foam material has a closed cell structure.

14. The diffuser of claim 11, wherein the foam material is a metal foam.

15. The diffuser of claim 11, further comprising a coating disposed on the foam material.

16. The diffuser of claim 15, wherein the coating is a ceramic material.

17. The diffuser of claim 15, wherein the coating is a metallic material.

18. The diffuser of claim 15, wherein the first splitter component and the second splitter component each have a flowpath surface; and wherein the coating is disposed on the flowpath surface of each of the first splitter component and the second splitter component.

19. A gas turbine engine, comprising:
a compressor;
means for diffusing pressurized air received from the compressor;
a combustor in fluid communication with the means for diffusing; and
a turbine in fluid communication with the combustor,
wherein the means for diffusing is formed at least in part of a first foam material.

20. The gas turbine engine of claim 19, wherein the combustor includes a dome panel; and wherein the dome panel is formed of a second foam material.

21. The gas turbine engine of claim 20, further comprising a thermal protection coating disposed on the second foam material.

22. The gas turbine engine of claim 19, wherein the combustor includes a combustion liner formed at least in part of a third foam material.

23. The gas turbine engine of claim 22, further comprising a thermal protection coating disposed on the third foam material.
